(19) United States
(12) Patent Application Publication
(10) Pub. No.: US 2017/0286823 A1
(43) Pub. Date: Oct. 5, 2017

(54) ELECTRONIC CERTIFICATE AND DISPLAY METHOD THEREFOR

(71) Applicant: BOE TECHNOLOGY GROUP CO., LTD., Beijing (CN)

(72) Inventors: Junwei YAN, Beijing (CN); Jiangbo WANG, Beijing (CN)

(73) Assignee: BOE TECHNOLOGY GROUP CO., LTD., Beijing (CN)

(21) Appl. No.: 15/510,822

(22) PCT Filed: Mar. 16, 2016
(86) PCT No.: PCT/CN2016/076471

§ 371 Date: Mar. 13, 2017

(30) Foreign Application Priority Data
Apr. 13, 2015 (CN) 201510172900.9

(51) Int. Cl. G06K 19/10; G09G 3/3208; G06K 19/07; G06F 21/32; G06F 21/33; G06K 9/00; G06F 21/84

(52) U.S. Cl. CPC G06K 19/10; G06K 9/00013; G06K 9/00228; G09G 3/3208; G06K 9/00087; G06K 9/00288; G06F 21/84; G06F 21/32; G06F 21/33; G06K 19/07; G09G 2330/02; G09G 2354/00; G09G 2358/00

(57) ABSTRACT

An electronic certificate and a display method therefor are disclosed. The electronic certificate includes an electronic certificate body, a display screen and an IC. The display screen is disposed on the front side of the electronic certificate body and is used for displaying project information of the electronic certificate. When the display screen is in a locked state, the display screen does not display any project information. The IC is connected to the display screen and is used for controlling a display function of the display screen.

### TECHNICAL FIELD

Embodiments of the disclosure relate to an electronic certificate and a display method thereof.

### BACKGROUND

A certificate is a certification and documents to prove identity, experiences etc., for example, a resident identification card, a passport, work card, a student's identity card, and a graduation certificate etc., on which personal information of a holder of the electronic certificate is registered. The identification card which is used most widely is illustrated as an example. Registration content of the identification card comprises name, gender, nation, birthday, address where registered resident is, citizen identification number, photograph of the holder, expire date of the certificate and issuing authority, so that it can prove identity of the holder.

However, the certificate is always lost due to wide and frequent use, and if the certificate is lost, the holder of the certificate will be in trouble even serious social problems will occur. For example, if the resident identification card is lost, the lost resident identification card can still be used normally, even though the lost card is reissued. This is because no cancellation measurement is available at present. It is known that, many lost or stolen identification cards are used to make illegal transactions by networks, and are widely used for illegal activities, such as opening bank cards and credit cards, shelter for fraudulent activity, and money laundering. As is illustrated, the certificate in prior art has low security.

### SUMMARY

Some embodiments of the disclosure disclose An electronic certificate, comprising: an electronic certificate body; a display screen, provided on a front side of the electronic certificate body, and configured to display item information of the electronic certificate, wherein, the display screen does not display any item information upon the display screen being in a locked state; and an integrated circuit (IC), connected with the display screen, and configured to control a display function of the display screen.

Some embodiments of the disclosure disclose a displaying method of an electronic certificate comprising inputting information for verification on the electronic certificate; determining whether the input information for verification is consistent with pre-stored information, according to the input information for verification; and displaying item information of the electronic certificate when the information for verification is consistent with the pre-stored information.

Some embodiments of the disclosure disclose an electronic certificate comprising: a processor; a memory, and computer program instructions stored in the memory, and the following steps being performed when the computer program instructions are executed by the processor: receiving information for verification input by a holder of the electronic certificate on the electronic certificate; determining if the input information for verification is consistent with pre-stored information, according to the information for verification; and displaying item information of the electronic certificate if the information for verification is consistent with the pre-stored information.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1a is an exemplary main view of an electronic certificate provided by a first embodiment of the disclosure;

FIG. 1b is an exemplary side view of the electronic certificate provided by the first embodiment of the disclosure;

FIG. 2 is another exemplary structure diagram of the electronic certificate provided by the first embodiment of the disclosure;

FIG. 3 is another exemplary structure diagram of the electronic certificate provided by the first embodiment of the disclosure;

FIG. 4 is an exemplary structure diagram of the electronic certificate provided by the first embodiment of the disclosure;

FIG. 5 is a flow chart of a method of displaying an electronic certificate provided a second embodiment of the disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

### First Embodiment

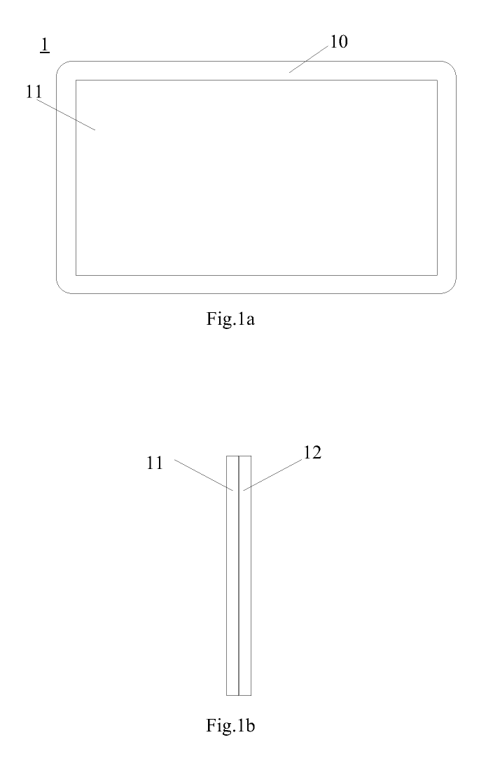

The first embodiment of the disclosure provides an electronic certificate. The electronic certificate can be a resident identification card, a passport, a visa, a student's identity card, a work card, a residential card, a graduation certificate, and any other kind of certification and documents to prove identity, experiences etc. FIG. 1a is an exemplary main view of the electronic certificate, and FIG. 1b is an exemplary side view of the electronic certificate. As is illustrated in FIG. 1a in combination with FIG. 1b, the electronic certificate 1 comprises an electronic certificate body 10, a display screen 11 and an integrated circuit (IC) 12.

The display screen 11 is provided on a front side of the electronic certificate body 10, to display item information of the electronic certificate 1. When the display screen 11 is in a locked state, the display screen 11 does not display any item information.

The IC 12 is connected with the display screen, to control a display function of the display screen 11.

Usually, the display screen 11 of the electronic certificate 1 is in the locked state, and it does not display any item information. Thus, anyone who is not a holder of the certificate will not obtain or even use any item information of the electronic certificate. When information related to the holder of the electronic certificate is required to be displayed, the electronic certificate receives verification information input by the holder of the electronic certificate, and then determines if the verification information is consistent with pre-stored information by the IC 12 which controls the display screen to display. If the verification information is consistent with the pre-stored information, the unlocked display screen 11 can display the item information of the electronic certificate.

In the embodiment of the disclosure, the item information of the electronic certificate refers to information such as words, digits and images that can prove identity or experiences etc. of the holder of the electronic certificate. An example is illustrated below in which the electronic certificate is the identification card. The item information of the identification card comprises information, such as name, gender, nation, birthday, address where registered resident is, citizen identification number, photograph of the holder, etc.

It should be noted that, a program or passport can be provided in the IC to prevent information from leakage, because the item information of the holder of the certificate and the preset verification information are stored in the IC of the embodiment of the disclosure. The program or the passport only can be operated or obtained by a specific department which issued the certificate, so that only the specific department can obtain or change the item information and the verification information in the IC.

The first embodiment of the disclosure provides an electronic certificate. The electronic certificate comprises an electronic certificate body, a display screen and an IC. The display screen is provided on a front side of the electronic certificate body, to display item information of the electronic certificate, wherein the display screen does not display any item information, when the display screen is in a locked state; the IC is connected with the display screen, to control a display function of the display screen. The electronic certificate is provided with the display screen and the IC which controls the display screen to display, so the item information of the electronic certificate only can be displayed on the display screen by the holder of the electronic certificate, and cannot be displayed by anyone who is not the holder of the electronic certificate, so that the item information would not be used to engage illegal activities, to improve security of the electronic certificate.

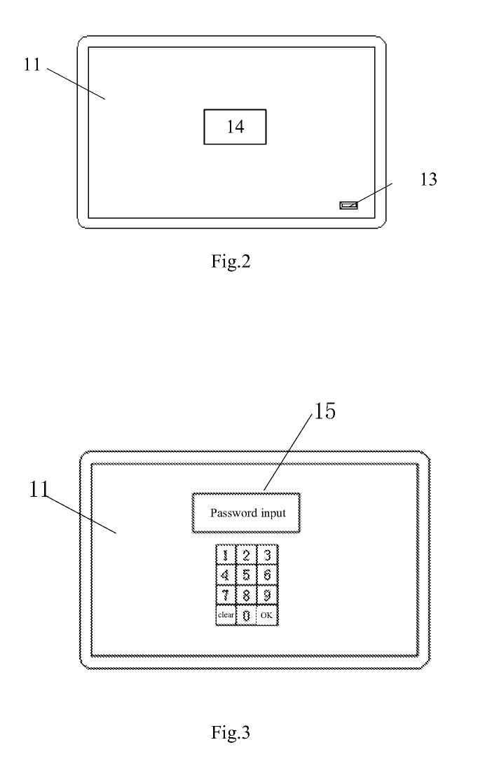

In an implementation of the embodiment of the disclosure, as illustrated in FIG. 2, the electronic certificate 1 further comprises a fingerprint recognition module 13 to recognize a fingerprint of the holder of the certificate. The fingerprint recognition module 13 is connected with the IC 12. In this case, the IC 12 is further configured to determine whether fingerprint information input from the fingerprint recognition module 13 by the holder of the certificate is correct.

Usually, the electronic certificate is in the locked state. When a finger of the holder of the certificate touches a region which can be recognized on the electronic certificate, fingerprint image information of the holder of the certificate is acquired by the fingerprint recognition module 13 and the acquired fingerprint image information is sent to the IC, so that the IC determines whether the fingerprint image information matches with pre-stored fingerprint information. The pre-stored information is stored in a storage module of the IC 12. If the fingerprint image information does not match with the pre-stored fingerprint information, the IC 12 can display prompt information like “fingerprint is error” by the display screen to prompt the holder of the certificate to re-input. If the fingerprint image information matches with the pre-stored fingerprint information, the IC 12 can display prompt information like “fingerprint is correct” by the display screen to inform the holder of the certificate that the input fingerprint information is correct or unlock the display screen directly.

FIG. 2 only illustrates that the fingerprint recognition module 13 is provided on lower right on the front side of the electronic certificate. However, it should be understood that, the fingerprint recognition module can be provided on any position on the electronic certificate, for example, on lower left on the front side of the electronic certificate, or on a position on the lateral side or back side of the electronic certificate, etc. The fingerprint recognition module 13 is provided on lower right on the front side of the electronic certificate, which may be more compliant with right-handed habit of human, that is, human often use his or her right hand to hold the electronic certificate, and the item information is usually arranged on positions on upper part and right part of the front side of the electronic certificate. Therefore, in some embodiments, the fingerprint recognition module can be provided on lower right on the front side of the electronic certificate.

The fingerprint recognition module of the implementation of the disclosure can be an element, such as a scratch type fingerprint sensor and a press type fingerprint sensor.

In another implementation of the embodiment of the disclosure, the electronic certificate 1 further comprises a face recognition module 14 to recognize a face of the holder of the certificate. The face recognition module 14 is connected with the IC 12. In this case, the IC 12 is further configured to determine whether face information input from the face recognition module 14 by the holder of the certificate is correct.

Usually, the electronic certificate is in the locked state. When a facial portion or face of the holder of the certificate is in a region which can be recognized on the electronic certificate, face image information of the holder of the certificate is acquired by the face recognition module 14 and the acquired face image information is sent to the IC 12, so that the IC 12 determines whether the face image information matches with pre-stored face information. The pre-stored face information is stored in a storage module of the IC 12. If the face image information does not match with the pre-stored face information, the IC 12 can display prompt information like “error” by the display screen to prompt the holder of the certificate to re-input. If the face image information matches with the pre-stored face information, the IC 12 can display prompt information like “correct” by the display screen to inform the holder of the certificate that the input face information is correct or unlock the display screen directly.

The face recognition module 14 can be provided on a center of the front side of the electronic certificate, and can also be provided on other positions of the electronic certificate. For example, it can be provided on right part or left part of the front side of the electronic certificate where the face of the holder can be recognized.

The face recognition module of the implementation of the disclosure can be an element, such as a micro-camera and an image sensor.

It should be noted that, in addition to above mentioned fingerprint recognition module and face recognition module, the electronic certificate of the embodiment of the disclosure can comprise a voice recognition module which recognizes with audio frequency and tone color or an eye recognition module which acquires iris image with infrared. All of these recognition modules can improve security for the item information of the electronic certificate on the display to a great extent.

In a third implementation of the embodiment of the disclosure, as illustrated in FIG. 3, the electronic certificate further comprises a passport unlock module 15 to recognize input from the holder of the certificate. The passport unlock module 15 is connected with the IC 12. In this case, the IC 12 is further configured to determine whether passport information input from the passport unlock module 15 by the holder of the certificate is correct.

The electronic certificate is usually in the locked state and the electronic certificate would not display item information thereof in the locked state. Thus, if the holder of the certificate wants to display item information of the electronic certificate, he or she can input unlock passport on a passport unlock region of the display screen 11 firstly, so that the passport unlock module 15 obtains the unlock passport information input by the holder of the certificate from the passport unlock region and sends the information to the IC 12, in order that the IC 12 determines whether the information matches with pre-stored unlock passport information. The pre-stored unlock passport information is stored in the storage module of the IC 12.

FIG. 3 only illustrates a case that the passport unlock region is arranged in the center of the front side of the electronic certificate and a passport unlock manner is digit unlock. But in the disclosure, the position where the passport unlock region is arranged and the passport unlock manner are not limited to this, they can be other arrangement positions and unlock manners which are easily to occur to those skilled in related arts. For example, the passport unlock region is arranged on a back side of the electronic certificate, and the passport unlock manner is graph unlocking.

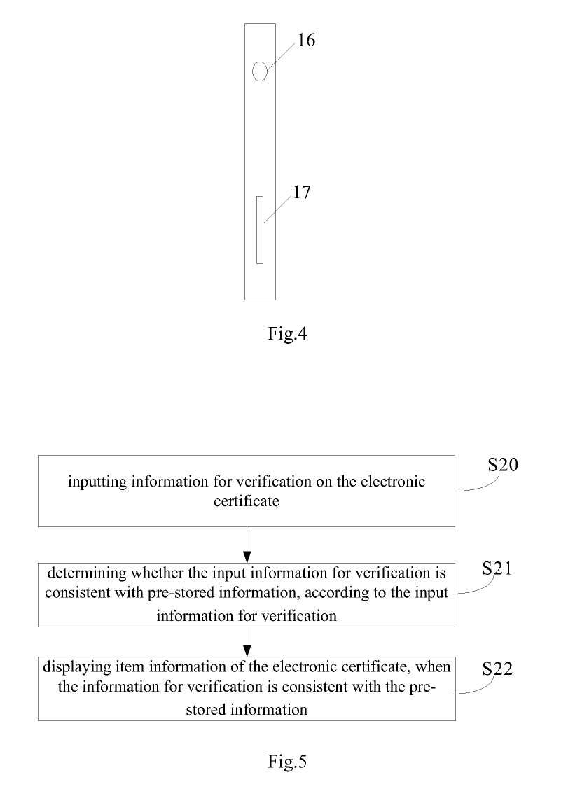

It takes into account that, if the display screen is still enabled and displays the item information after the holder of the certificate turns on the display screen and completes to use the item information, it will not only consume a large quantity of power of the electronic certificate, but also increase risk to leakage the information. Therefore, in an implementation of the disclosure, as illustrated in FIG. 4, the electronic certificate 1 further comprises a switch 16 to turn on or off the display screen 11, and the switch 16 is provided in the electronic certificate body 10.

For example, the electronic certificate 1 further can be provided with a switch 16 to turn on or off the display screen 11. The switch can adopt button manner or push manner to switch on and switch off. When the switch 16 is switched on, the display screen is turned on, and the display screen turned on is in the locked state. When the switch 16 is switched off, the display screen is turned off in spite that the display screen 11 is in the locked state or in the unlocked state to display the item information.

It can be seen from above, the switch 16 can control the display screen 11 to be turned on or off. When the item information needs not to be displayed, the display screen can be turned off by switching off the switch 16. In this way, it can not only save electric quantity of the electronic, but also avoid the item information to be illegally used by anyone who is not the holder of the certificate.

It should be noted that, FIG. 4 only illustrates a case that the switch 16 is provided on a lateral side of the electronic certificate. In a practical application, the switch 16 also can be provided on other positions, for example, the back side of the electronic certificate.

In an implementation of the disclosure, still refer to FIG. 4, the electronic certificate 1 further comprises a battery chamber 17. The battery chamber 17 is provided in the electronic certificate body 10, and a battery mounted in the battery chamber 17 can supply power to the display screen 11 and the IC 12.

It can be understood that, the battery of the embodiment of the disclosure is preferably thin and small, and the battery which uses the battery chamber is preferably light and small. In this way, it facilitates the holder of the certificate to carry the electronic certificate with the battery chamber.

In an implementation of the disclosure, the display screen 11 is an OLED (Organic Light-Emitting Diode) display screen.

The display screen which adopt material of OLED has advantages of self luminescence, no back light source, thin thickness, wide view angle, fast reaction rate, wide usage temperature rang etc.

### Second Embodiment

The second embodiment of the disclosure provides a method of displaying the electronic certificate. As is illustrated in FIG. 5, the method comprises steps as follows:

inputting information for verification on the electronic certificate;

determining whether the input information for verification is consistent with the pre-stored information, according to the input information for verification; and

displaying item information of the electronic certificate, when the information for verification is consistent with the pre-stored information.

In above steps, the information for verification can comprise at least one of passport unlock information, face recognition information and fingerprint recognition information.

In particular, the passport unlock information can be passport unlock representation in form of digital combination, and also can be passport unlock representation in form of graph combination. The passport unlock information is obtained and sent by the passport unlock module. The face recognition information and the fingerprint recognition information can be acquired and sent by the face recognition module and the fingerprint recognition module respectively.

In addition, before the step of inputting information for verification on the electronic certificate, a following step can be comprised: turning on a display screen of the electronic certificate.

A switch can be provided, to control the display screen to be turned on or off. The display screen turned on by the switch can be in the locked state.

Corresponding to the above step, the method of displaying the electronic certificate can further comprise a step of turning off the display screen of the electronic certificate.

For example, the display screen of the electronic certificate can be turned off by the switch. In particular, the display screen of the electronic certificate can be turned off by the switch whether the display screen is displaying item information or not. Thus, it not only saves electric quantity of the electronic certificate, but also prevents the item information from leakage.

The second embodiment of the disclosure provides a method of displaying the electronic certificate. The method comprises inputting information for verification on the electronic certificate; and displaying item information of the electronic certificate, when the information for verification is consistent with the pre-stored information. The Information for verification is input on the electronic certificate, and the item information of the electronic certificate is displayed when the information for verification is correct, so that the item information of the electronic certificate only can be displayed on the display screen by the holder of the electronic certificate, and cannot be displayed by anyone who is not the holder of the electronic certificate, in order that the item information cannot be used to engage illegal activities, and therefore the security of the electronic certificate is improved.

It should be noted that, respective steps of the method of the second embodiment are implemented by respective function modules of the first embodiment.

For example, in the electronic certificate of the embodiment of the disclosure, the integrated circuit can comprise a processor and a memory. The electronic certificate further comprises computer program instructions stored in the memory. When the computer program instructions are executed by the processor, the computer program instructions execute following steps: receiving information for verification input by the holder of the electronic certificate; determining if the information for verification is consistent with pre-stored information; displaying item information of the electronic certificate, if the information for verification is consistent with the pre-stored information. The input information comprises at least one of passport unlock information, face recognition information or fingerprint recognition information. The information can be input by at least one of a passport input device, a fingerprint recognition device or a face acquisition device.

What are described above is related to the illustrative embodiments of the disclosure only and not limitative to the scope of the disclosure; the scopes of the disclosure are defined by the accompanying claims.

The application claims priority to the Chinese patent application No. 201510172900.9, filed Apr. 13, 2015, the entire disclosure of which is incorporated herein by reference as part of the present application.

1. An electronic certificate, comprising:
an electronic certificate body;
a display screen, provided on a front side of the electronic certificate body, and configured to display item information of the electronic certificate, wherein, the display screen does not display any item information upon the display screen being in a locked state; and
an integrated circuit (IC), connected with the display screen, and configured to control a display function of the display screen.

2. The electronic certificate of claim 1. further comprising a fingerprint recognition module, configured to recognize a fingerprint of a holder of the certificate and connected with the IC, and the IC being further configured to determine whether fingerprint information input from the fingerprint recognition module by the holder of the certificate is correct.

3. The electronic certificate of claim 1, further comprising a face recognition module, configured to recognize a face of a holder of the certificate and connected with the IC, and the IC being further configured to determine whether face information input from the face recognition module by the holder of the certificate is correct.

4. The electronic certificate of claim 1, further comprising a passport unlock module, configured to recognize input from a holder of the certificate and connected with the IC, and the IC being further configured to determine whether passport information input from the passport unlock module by the holder of the certificate is correct.

5. The electronic certificate of claim 1, further comprising a switch, configured to turn on or off the display screen and provided in the electronic certificate body.

6. The electronic certificate of claim 1, further comprising a battery chamber for mounting a battery therein and provided in the electronic certificate body, wherein the battery mounted in the battery chamber is capable of supplying power to the display screen and the IC.

7. The electronic certificate of claim 1, wherein, the display screen is an organic light emitting diode (OLED) display screen.

8. A displaying method of an electronic certificate, comprising
inputting information for verification on the electronic certificate;
determining whether the input information for verification is consistent with pre-stored information, according to the input information for verification; and
displaying item information of the electronic certificate when the information for verification is consistent with the pre-stored information.

9. The displaying method of claim 8, wherein, the information for verification comprises at least one of passport unlock information, face recognition information or fingerprint recognition information.

10. An electronic certificate, comprising:
a processor;
a memory, and
computer program instructions stored in the memory, and the following steps being performed when the computer program instructions are executed by the processor:
receiving information for verification input by a holder of the electronic certificate on the electronic certificate;
determining if the input information for verification is consistent with pre-stored information, according to the information for verification; and
displaying item information of the electronic certificate if the information for verification is consistent with the pre-stored information.

11. The electronic certificate of claim 10, wherein, the input information comprises at least one of passport unlock information, face recognition information or fingerprint recognition information.

12. The electronic certificate of claim 10, further comprising at least one of a passport input device, a fingerprint recognition device or a face acquisition device, for inputting information on the electronic certificate.

13. The electronic certificate of claim 2, further comprising a switch, configured to turn on or off the display screen and provided in the electronic certificate body.

14. The electronic certificate of claim 2, further comprising a battery chamber for mounting a battery therein and provided in the electronic certificate body, wherein the battery mounted in the battery chamber is capable of supplying power to the display screen and the IC.

15. The electronic certificate of claim 2, wherein, the display screen is an organic light emitting diode (OLED) display screen.
